(19) United States
(12) Patent Application Publication
(10) Pub. No.: US 2011/0063552 A1
(43) Pub. Date: Mar. 17, 2011

(54) LIQUID CRYSTAL DISPLAY DEVICE, AND LIQUID CRYSTAL CELL

(75) Inventor: Mitsuyoshi Ichihashi, Kanagawa (JP)

(73) Assignee: FUJIFILM Corporation, Minato-ku, Tokyo (JP)

(21) Appl. No.: 12/992,186

(22) PCT Filed: May 7, 2009
(86) PCT No.: PCT/JP2009/001997

§ 371 Date: Nov. 11, 2010

(30) Foreign Application Priority Data
May 12, 2008 (JP) 2008-124259

(51) Int. Cl. G02F 1/1335

(52) U.S. Cl. 349/117

(57) ABSTRACT

Disclosed a liquid crystal display device comprising at least one polarizing plate; and a liquid crystal cell comprising a multi-domain liquid crystal layer (16) comprising positive-birefringent liquid crystal molecules, and a multi-domain retardation layer (18) disposed between the liquid crystal layer and at least one of the two substrates, and comprising negative-birefringent molecules fixed in an alignment; the liquid crystal molecules in the liquid crystal layer (16) being tilt-aligned in the black state so that the averaged tilt angle falls in the range from more than 1° to not more than 20°, with respect to the direction of normal lines of the two substrates, and having directions of tilting of the liquid crystal molecules different between at least two domains, and the retardation layer (18) having retardation in-plane at 550 nm, Re(550), of equal to or smaller than 20 nm, and having directions of in-plane slow axis different between at least two domains.

### TECHNICAL FIELD

The present invention relates to a multi-domain-type liquid crystal display device and a liquid crystal cell.

### BACKGROUND ART

A variety of proposals have been made on so-called, multi-domain-type liquid crystal display device (for example, liquid crystal display devices employing an MVA (Multi-domain Vertical Alignment) mode and a PVA (Patterned Vertical Alignment) mode), which contain a plurality of domains having different states of alignment in a single pixel (or subpixel). Conventionally, alignment of liquid crystal molecules in the individual domains has been regulated, making use of substrate structures such as ribs, slits and so forth. However, due to geometrical anisotropy of the structures, the regulatory force of alignment to be exerted on the liquid crystal molecules may occasionally become non-uniform in a single pixel, and may thereby induce distribution in the response speed. Another problem may be lowering in the overall luminance of display, since transmissivity of light decreases in regions having the slits or ribs formed therein.

Japanese Laid-Open Patent Publication No. 2002-357830 (US2009/0059148A1) proposes a multi-domain-type liquid crystal display device, making use of a divisionally-aligned alignment film such as photo-alignable film. This sort of liquid crystal display device no longer needs slits or ribs which are causative of lowered transmissivity of light and non-uniformity in the response performance. On the other hand, Japanese Laid-Open Patent Publication No. 2007-256811 discloses that a liquid crystal display device, making use of the slits or ribs, successfully improves the response performance, by giving a pre-tilt angle to the liquid crystal molecules.

By the way, it has been known that, in a mode such as the VA (Vertical Alignment) mode, by which the black state and the white state are switched over by tilting the liquid crystal molecules from the vertically aligned state, operational characteristics such as response performance may be improved by preliminarily aligning the liquid crystal molecules while being inclined to some degree. The larger the tilt angle of the liquid crystal molecules in the black state would be, the larger an effect of improving the operational characteristics would be, whereas, the larger the tilt angle would be, the larger the degradation of contrast in the axial view (direction of normal line on the screen) would be. In consideration of this problem, the present inventors made an effort of suppressing the degradation of contrast ascribable to the tilt-alignment in the liquid crystal layer in the black state, by disposing various commercially-available retardation film between the polarizing plate and the liquid crystal panel, only to find that it was difficult to suppress it with the conventional retardation film.

It is therefore an object of the present invention to provide a multi-domain-type liquid crystal display device having a high contrast and improved operation characteristics.

It is another object of the present invention to provide a novel multi-domain-type liquid crystal cell.

### Means for Solving the Problems

The present invention relates to a multi-domain-type liquid crystal display device. Unlike the conventional multi-domain-type liquid crystal display device in which the liquid crystal molecules vertically align in the black state, the present invention improves the operation characteristics by tilt-aligning liquid crystal molecules in the black state at a small tilt angle (more specifically, at a tilt angle exceeding 1° and not exceeding 20°), and cancels birefringence ascribable to such tilt-alignment of the liquid crystal molecules in the black state, by using a multi-domain retardation layer disposed in the cell, and composed of a negative-birefringent material.

One known type of multi-domain-type liquid crystal display device is such that the liquid crystal cell thereof has a retardation layer which contains a plurality of domains having different directions of alignment (for example, Japanese Laid-Open Patent Publication No. 2006-276849 (corresponding to WO2006/093358A1)). The liquid crystal display device is aimed at moderating coloration in oblique directions in the black state, ascribable to that the absorption axes of the polarizing plates shift from the orthogonal arrangement when viewed in oblique directions, and is therefore different from the liquid crystal display device of the present invention.

In particular, the means for solving the problems are as follows.

[1] A liquid crystal display device comprising:

at least one polarizing plate; and

a liquid crystal cell comprising at least:
two substrates,
a multi-domain liquid crystal layer disposed between the two substrates, and comprising positive-birefringent liquid crystal molecules, and
a multi-domain retardation layer disposed between the liquid crystal layer and at least one of the two substrates, and comprising negative-birefringent molecules fixed in an alignment;

the liquid crystal molecules in the liquid crystal layer being tilt-aligned in the black state so that the averaged tilt angle falls in the range from more than 1° to not more than 20°, with respect to the direction of normal lines of the two substrates, and having directions of tilting of the liquid crystal molecules different between at least two domains, and

the retardation layer having retardation in-plane at 550 nm, Re(550), of equal to or smaller than 20 nm, and having directions of in-plane slow axis different between at least two domains.

[2] The liquid crystal display device of [1],

wherein the direction of tilting of the liquid crystal molecules in a domain of the liquid crystal layer intersects with the in-plane slow axis of a domain of the retardation layer corresponding to the domain of the liquid crystal layer when projected onto the same plane.

[3] The liquid crystal display device of [1],

wherein the direction of tilting of the liquid crystal molecules in a domain of the liquid crystal layer intersects with the in-plane slow axis of a domain of the retardation layer, corresponding to the domain of the liquid crystal layer, by 90° when projected onto the same plane.

[4] The liquid crystal display device of [1],

wherein the in-plane slow axis of each of the domains in the retardation layer is not parallel to the absorption axis of the at least one polarizing plate or not orthogonal to the absorption axis of the at least one polarizing plate.

[5] The liquid crystal display device of any one of [1]-[4],

wherein the direction of tilting of the liquid crystal molecules in a domain of the liquid crystal layer is same as the direction of tilting of the directors of the negative-birefringent molecules in a domain of the retardation layer corresponding to the domain of the liquid crystal layer.

[6] The liquid crystal display device of any one of [1]-[5],

wherein the retardation layer comprises discotic molecules fixed in a state of normal hybrid alignment or in a state of reverse hybrid alignment.

[7] The liquid crystal display device of any one of [1]-[6],

wherein corresponding domains of the liquid crystal layer and the retardation layer are layers formed on surfaces rubbed in parallel to each other in reverse directions.

[8] The liquid crystal display device of any one of [1]-[7],

wherein the liquid crystal layer and the retardation layer respectively have four domains corresponding to each other, and the positive-birefringent liquid crystal molecules in the liquid crystal layer in the black state and the negative-birefringent molecules in the retardation layer are aligned in the directions of 45°, 135°, 225° and 315° in the four domains respectively.

[9] The liquid crystal display device of any one of [1]-[8],

wherein the liquid crystal layer has two interfaces with different tilt angles of the liquid crystal molecules each other, and the retardation layer is disposed closer to the interface with a larger tilt angle of the different tilt angles.

[10] The liquid crystal display device of any one of [1]-[9], which employs a VA mode.
[11] The liquid crystal display device of any one of [1]-[10],

wherein the negative-birefringent molecules are molecules of a discotic liquid crystalline compound.

[12] The liquid crystal display device of [11],

wherein the discotic liquid crystalline compound is a tri-substituted benzene derivative.

[13] The liquid crystal display device of any one of [1]-[12],

wherein the retardation layer is a cured film of a composition which comprises at least a discotic liquid crystalline compound, and a compound having a fluorinated alkyl group.

[14] A liquid crystal cell comprising:
two substrates;
a multi-domain liquid crystal layer disposed between the two substrates, and comprising positive-birefringent liquid crystal molecules; and
a multi-domain retardation layer disposed between the liquid crystal layer and at least one of the two substrates, and comprising negative-birefringent molecules fixed in an alignment;

the liquid crystal molecules in the liquid crystal layer being tilt-aligned in the black state so that the averaged tilt angle falls in the range from more than 1° to not more than 20°, with respect to the direction of normal lines of the two substrates, and having directions of tilting of the liquid crystal molecules different between at least two domains, and

the retardation layer having retardation in-plane at 550 nm, Re(550), of equal to or smaller than 20 nm, and having directions of in-plane slow axis different between at least two domains.

### BRIEF DESCRIPTION OF THE DRAWINGS

FIG. 1 is a schematic sectional view illustrating one embodiment of a liquid crystal cell of the present invention;

FIG. 2 is a drawing schematically illustrating an exemplary relation of optical directions between a liquid crystal layer and a retardation layer of the liquid crystal cell of the present invention, and among these layers and polarizing plates;

FIG. 3 is a drawing schematically illustrating another exemplary relation of optical directions between a liquid crystal layer and a retardation layer of the liquid crystal cell of the present invention, and among these layers and polarizing plates;

FIG. 4 is a schematic sectional view illustrating another embodiment of the liquid crystal cell of the present invention;

FIG. 5 is a schematic sectional view illustrating still another embodiment of the liquid crystal cell of the present invention;

FIG. 6 is a schematic sectional view illustrating one embodiment of the liquid crystal display device of the present invention; and

FIG. 7 is a drawing schematically illustrating an exemplary relation of optical directions of the individual components in the liquid crystal display device of the present invention.

### MODE FOR CARRYING OUT THE INVENTION

The present invention will be detailed below. Note that all numerical ranges expressed in this patent specification using “to” means the ranges containing the numerals placed before and after “to” as the lower limit value and the upper limit value, respectively.

In this description, Re(λ) and Rth(λ) are retardation (nm) in-plane and retardation (nm) along the thickness direction, respectively, at a wavelength of λ. Re(λ) is measured by applying light having a wavelength of λ nm to a film in the normal direction of the film, using KOBRA 21ADH or WR (by Oji Scientific Instruments). The selectivity of the measurement wavelength λ nm may be conducted by a manual exchange of a wavelength-filter, a program conversion of a measurement wavelength value or the like.

When a film to be analyzed can be expressed by a monoaxial or biaxial index ellipsoid, Rth(λ) of the film is calculated as follows.

Rth(λ) is calculated by KOBRA 21ADH or WR on the basis of six Re(λ) values which are measured for incoming light of a wavelength λ nm in six directions which are decided by a 10° step rotation from 0° to 50° with respect to the normal direction of a sample film using an in-plane slow axis, which is decided by KOBRA 21ADH, as an inclination axis (a rotation axis; defined in an arbitrary in-plane direction if the film has no slow axis in plane); a value of hypothetical mean refractive index; and a value entered as a thickness value of the film.

In the above, when the film to be analyzed has a direction in which the retardation value is zero at a certain inclination angle, around the in-plane slow axis from the normal direction as the rotation axis, then the retardation value at the inclination angle larger than the inclination angle to give a zero retardation is changed to negative data, and then the Rth(λ) of the film is calculated by KOBRA 21ADH or WR.

Around the slow axis as the inclination angle (rotation angle) of the film (when the film does not have a slow axis, then its rotation axis may be in any in-plane direction of the film), the retardation values are measured in any desired inclined two directions, and on the basis of the data, the estimated value of the mean refractive index, and the inputted film thickness value, Rth may be calculated according to the following formulae (7) and (8):

$$[ Numerical Formula 1 ]$$

$$\begin{matrix}Re ( θ ) = [ nx - \frac{ny \times nz}{\sqrt{\begin{matrix}{\{ ny sin ( {sin}^{- 1} ( \frac{sin ( - θ )}{nx} ) ) \}}^{2} + \\ {\{ nz cos ( {sin}^{- 1} ( \frac{sin ( - θ )}{nx} ) ) \}}^{2}\end{matrix}}} ] \times \frac{d}{cos \{ {sin}^{- 1} ( \frac{sin ( - θ )}{nx} ) \}} \\ [ Numerical Formula 2 ] & Numerical Formula ( 11 ) \\ Rth = ( \frac{nx + ny}{2} - nz ) \times d & Numerical Formula ( 12 )\end{matrix}$$

In the formulas, Re(θ) represents a retardation value in the direction inclined by an angle θ from the normal direction; nx represents a refractive index in the in-plane slow axis direction; ny represents a refractive index in the in-plane direction orthogonal to nx; and nz represents a refractive index in the direction orthogonal to nx and ny. And “d” is a thickness of the sample.

When the film to be analyzed is not expressed as a monoaxial or biaxial index ellipsoid, or that is, when the film does not have any optical axis, then Rth(λ) of the film may be calculated as follows:

Re(λ) of the film is measured around the slow axis (judged by KOBRA 21ADH or WR) as the in-plane inclination axis (rotation axis), relative to the normal direction of the film from −50 degrees up to +50 degrees at intervals of 10 degrees, in 11 points in all with a light having a wavelength of λ nm applied in the inclined direction; and on the basis of the thus-measured retardation values, the estimated value of the mean refractive index and the inputted film thickness value, Rth(λ) of the film may be calculated by KOBRA 21ADH or WR.

In the above-described measurement, the hypothetical value of mean refractive index is available from values listed in catalogues of various optical films in Polymer Handbook (John Wiley & Sons, Inc.). Those having the mean refractive indices unknown can be measured using an Abbe refract meter. Mean refractive indices of some main optical films are listed below:

cellulose acylate (1.48), cycloolefin polymer (1.52), polycarbonate (1.59), polymethylmethacrylate (1.49) and polystyrene (1.59).

KOBRA 21ADH or WR calculates nx, ny and nz, upon enter of the hypothetical values of these mean refractive indices and the film thickness. On the basis of thus-calculated nx, ny and nz, Nz=(nx−nz)/(nx−ny) is further calculated.

And, if there is not any notation regarding the wavelength for the measurement, the wavelength for the measurement is 550 nm.

In this description, “tilt angle” of the liquid crystal molecule in the liquid crystal layer to be driven, means an angle formed between the normal line of the layer and the long axis of the liquid crystal molecule. The tilt angle is variable in the range from 0° to 90°, where the direction of the normal line is defined as 0°, and an arbitrary in-plane direction on the displaying plane is defined as 90°. The “direction of tilting” of the liquid crystal molecules in the liquid crystal layer to be driven, is represented by an in-plane direction observed when the long axis of the inclined liquid crystal molecule is projected on to a layer-plane, and, in this description, is defined as an azimuth (variable from 0° to 360°) in the layer-plane. In the description, the azimuth in this description is defined as 0° for the left, 90° for the top, 180° for the right, and 270° for the bottom of the displaying plane. The direction of tilting of the liquid crystal molecules in one domain means an average of the directions of tilting of the liquid crystal molecules in the domain.

On the other hand, the “tilt angle” of the molecules in the retardation layer means an angle formed between the normal line of the layer and the director of the molecules (for example, discotic liquid crystal molecule).

In this description, the “direction of tilting” of the liquid crystal molecules in one domain means an average direction of tilting of the liquid crystal molecules in the domain.

Note that all errors allowable in this technical field may be allowable also with respect to the numerical values described in this description.

Embodiments of the present invention will be described below, referring to the drawings. Note that the individual drawings are schematic ones, so that size, thickness and so forth of the individual layers are not always given in actual relative relations.

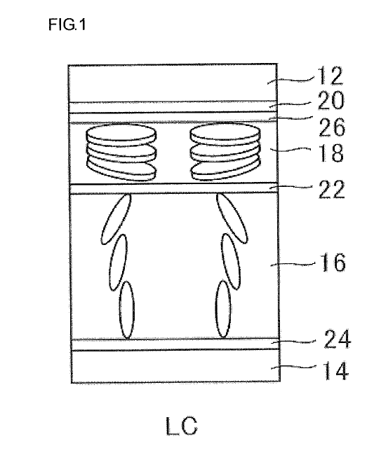

FIG. 1 is a schematic sectional view illustrating one embodiment of a liquid crystal cell of the present invention. A liquid crystal cell LC shown in FIG. 1 is one embodiment of a multi-domain, VA-mode liquid crystal cell LC.

The liquid crystal cell LC has a pair of substrates 12, 14, a liquid crystal layer 16 disposed between them, and a retardation layer 18 disposed between the liquid crystal layer 16 and the substrate 12. The liquid crystal cell LC is a liquid crystal cell for color display, and has a color filter 20 in the cell. One pixel of the color filter 20 is composed of RGB subpixels, and a region of the liquid crystal layer 16 corresponding to one subpixel is composed of a plurality of domains. Liquid crystal molecules in the liquid crystal layer 16 are tilt-aligned at a small tilt angle (more specifically, at a tilt angle of more than 1° and not more than 20°) in the black state, wherein the directions of tilting are different between at least two domains. On the other hand, also the retardation layer 18 is composed of a plurality of domains corresponding to the domains of the liquid crystal layer 16, wherein the directions of in-plane slow axis are different between at least two domains.

Note that other functional layers, such as electrode layers, arranged on the inner surfaces of the liquid crystal cell substrates, are not shown for simplicity of explanation. The same will apply also to the other drawings referred to later.

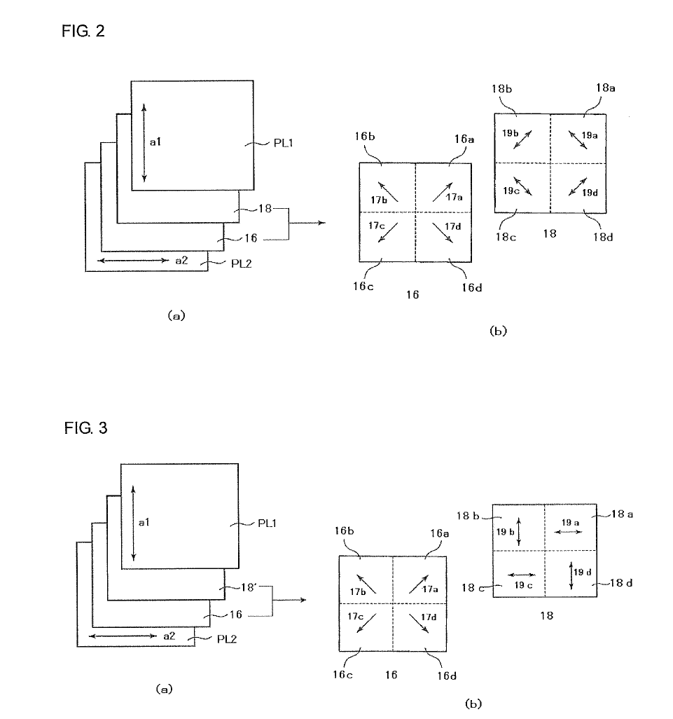

FIG. 2 schematically shows an exemplary relation of optical directions between a liquid crystal layer and a retardation layer corresponding to one subpixel of the liquid crystal cell LC, and among these layers and polarizing plates PL1 and PL2. In the example shown in FIG. 2, a region corresponding to one subpixel of each of the liquid crystal layer and the retardation layer is composed of four domains.

The liquid crystal cell LC shown in FIG. 2(a) is disposed between a pair of polarizing plates PL1 and PL2. As shown in FIG. 2(b), the region corresponding to one subpixel of the liquid crystal layer 16 is divided into four domains 16a, 16b, 16c and 16d, wherein the liquid crystal molecules in the individual domains have directions of tilting 17a, 17b, 17c and 17d different from each other. Azimuths of the directions of tilting are exemplified by a combination of 45°, 135°, 225° and 315°. The tilt angle of the liquid crystal molecules in the individual domains may be good enough so far as the operation characteristics may be improved, and so far as the contrast is not excessively degraded, and is typically more than 1° and not more than 20° on the average basis, and more preferably from 2 to 10°. The retardation layer 18 is quadrisectioned into domains 18a, 18b, 18c and 18d, corresponding to the domains 16a, 16b, 16c and 16d of the liquid crystal layer 16. The individual domains have in-plane slow axes 19a, 19b, 19c and 19d, respectively, wherein the in-plane slow axes 19a and 19c, and the in-plane slow axes 19b and 19d are aligned in directions different from each other. In one example, the in-plane slow axes 19a and 19c are aligned in the direction defined by an azimuth of 135° (315°), and the in-plane slow axes 19b and 19d are aligned in directions defined by an azimuth of 45° (225°). In the shown example, in the domains corresponding with each other between the liquid crystal layer 16 and the retardation layer 18 (for example, in the domain 16a and the domain 18a), the direction of tilting of the liquid crystal molecules intersects with the direction of in-plane slow axis (for example, 17a and 19a) at a 90° angle, or, that is, is orthogonal to the direction of in-plane slow axis (for example, 17a and 19a).

FIG. 3 is a schematic drawing of another example, as well as FIG. 2. Referring now to the in-plane slow axes of the individual domains of the retardation layer 18 in the shown example in FIG. 3, the in-plane slow axes 19a and 19c are aligned in the direction defined by an azimuth of 0° (180°), and the in-plane slow axes 19b and 19d are aligned in the direction defined by an azimuth of 90° (270°). In the shown example, in the domains corresponding with each other between the liquid crystal layer 16 and the retardation layer 18 (for example, in the domain 16a and the domain 18a), the direction of tilting of the liquid crystal molecules intersects with the direction of in-plane slow axis (for example, 17a and 19a) at a 45° angle.

As shown in FIG. 2(a) and FIG. 3(a), generally, in the VA mode, the polarizing plate PL1 and the polarizing plate PL2 are disposed so that the absorption axis a1 of the former and the absorption axis a2 of the latter are orthogonal to each other, and so that the one of them is along with the lateral direction of the displaying plane and the other of them is along with the vertical direction of the displaying plane. When the liquid crystal cell having the combination shown in FIG. 2(b) is disposed, the in-plane slow axes of the individual domains of the retardation layer are not parallel to the absorption axes of the polarizing plates, or not orthogonal to the absorption axes of the polarizing plates. If such relation is satisfied, asymmetries of Re in the normal direction and of birefringence in the direction with any polar angle, which are due to the tilt-alignment of the liquid crystal molecules in the liquid crystal layer with a small tilt angle, may be canceled. More specifically, in an exemplary case shown in FIG. 2(b), each of the in-plane slow axes 19a, 19b, 19c and 19d in the individual domains of the retardation layer 18 is not parallel or not orthogonal to the absorption axes a1 and a2 of the polarizing plates PL1 and PL2, but intersects with the absorption axes a1 and a2 of the polarizing plates PL1 and PL2 at a 45° angle. On the other hand, in an exemplary case shown in FIG. 3(b), each of the in-plane slow axes 19a, 19b, 19c and 19d of the individual domains of the retardation layer 18 is parallel to the absorption axes a1 and a2 of the polarizing plates PL1 and PL2 or orthogonal to the absorption axes a1 and a2 of the polarizing plates PL1 and PL2. In the exemplary case shown in FIG. 3(b), the retardation layer 18 is no longer successful in effectively compensating birefringence of the liquid crystal molecules in the liquid crystal layer. In addition, the obliqueness of the absorption axes of two polarizing plates adversely affects birefringence caused by the shift from the orthogonal relation

In FIG. 1, the liquid crystal layer 16 is a layer containing a positive-birefringent liquid crystal (for example, nematic liquid crystal), so that the direction of tilting of the liquid crystal molecules in the black state may be controllable by alignment treatment provided to the alignment films 22 and 24 shown in FIG. 1. For example, the direction of tilting may be controllable on the basis of the axis of rubbing when the alignment treatment is carried out by rubbing, or the direction of tilting may be controllable on the basis of the direction of irradiation or direction of polarization of light when the alignment treatment is carried out by irradiation of light. The plurality of domains with the directions of tilting being different from each other may be formed by using a mask, geometrically corresponding to each of the domains, when the rubbing treatment or the irradiation of light is carried out, or, that is, may be formed, for example, by carrying out the plurality times of a so-called masked rubbing treatment repeatedly. The liquid crystal layer 16 exemplified in FIG. 2(b) or FIG. 3(b) may be formed by using alignment film which is prepared by rubbing respectively in the directions same with the directions of tilting 17a, 17b, 17c and 17d of the liquid crystal molecules. On the other hand, the retardation layer 18 is a layer containing the negative-birefringent molecules fixed in an aligned manner, so that the in-plane slow axis of the layer may be controllable by alignment treatment of the alignment film 26 used when the layer is formed. Examples of the negative-birefringent material include discotic liquid crystal. The retardation layer, formed by allowing the discotic liquid crystal to align on the rubbed alignment film in an uniformly tilted manner or in a hybrid manner, and kept in such state of alignment, exhibits the in-plane slow axis in the direction orthogonal to the direction of rubbing of the alignment film. In order to satisfy the relation shown in FIG. 2(b) in this embodiment, the retardation layer 18 and the liquid crystal layer 16 are disposed so that the direction of tilting of the directors of the discotic molecules in each of the domains in the retardation layer 18 is nearly equal to the direction of tilting of long axes (17a, 17b, 17c and 17d in FIG. 2 and FIG. 3) of the liquid crystal molecules in the liquid crystal layer 16 corresponding to the domain.

In FIG. 1, retardation in-plane at 550 nm, Re(550), of the retardation layer 18 is preferably nearly equal to Δn·d at 550 nm of the liquid crystal layer in the black state (where, Δn represents birefringence of the liquid crystal layer, and d represents thickness of the liquid crystal layer). Too large Re(550) of the retardation layer 18 may result in reduced contrast in the normal direction. From this point of view, Re(550) of the retardation layer 18 is preferably equal to or smaller than 20 nm, and more preferably from 0.5 to 10 nm.

In FIG. 1, the liquid crystal layer 16 in the black state does not have a uniform tilt-alignment, instead having different tilt angles at the interfaces between itself and the alignment films 22 and 24, wherein the interface with the alignment film 22 has a larger tilt angle. This state of alignment may be formed by using materials having different regulatory force of alignment for the alignment films 22 and 24. Alternatively, vertical alignment films may be used for the alignment films 22 and 24, wherein only either one of which is rubbed. The retardation layer 18 in FIG. 1 exhibits a remarkable effect, since it is disposed at the interface on which the tilt angle of the liquid crystal layer 16 is larger. In FIG. 1, also the retardation layer 18 is a layer having a fixed state of so-called hybrid alignment with the tilt angle varying in the thickness direction. While the averaged tilt angle of the retardation layer 18 may be equal to the averaged tilt angle of the liquid crystal layer 16, the maximum tilt angle of the retardation layer 18 may be larger than the average tilt angle of the retardation layer 16, since the thickness of the retardation layer 18 is generally smaller than the thickness of the liquid crystal layer 16.

When a liquid crystal composition is applied to the alignment film to form a coated film, the coated film may have an interface on the alignment film side and an interface on the air side. The hybrid alignment means an alignment in which the tilt angles of liquid crystal molecules vary between the two interfaces. The hybrid alignment may be classified into “normal hybrid alignment” and “reverse hybrid alignment”, and the former is the alignment state in which the tilt angle at the interface on the alignment film side is smaller than the tilt angles at the interface on the air side, and the latter is the alignment state in which the tilt angle at the interface on the alignment film side is larger than the tilt angle at the interface on the air side. In the description, a simple terminology of “hybrid alignment” is used for covering both of the embodiments. The retardation layer 18 shown in FIG. 1 is an embodiment containing the liquid crystal molecules fixed in a normal hybrid alignment state.

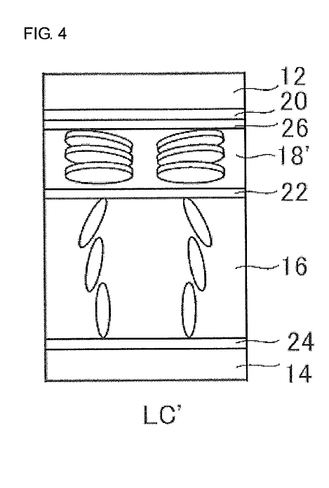

FIG. 4 shows a schematic sectional view of a liquid crystal cell LC′ according to another embodiment of the present invention. The liquid crystal cell LC′ shown in FIG. 4 is an embodiment having the same configuration as shown in FIG. 1, except that the retardation layer 18 is replaced with a retardation layer 18′. The retardation layer 18′ is an embodiment which contains the liquid crystal molecules fixed in a reverse hybrid alignment state. In the liquid crystal cell LC′ shown in FIG. 4, if the retardation layer 18′ and other optical components, including the liquid crystal layer 16, are disposed so that their optical directions satisfy the relation shown in FIG. 2, birefringence, which is caused due to alignment of liquid crystal molecules in the liquid crystal layer in the black state with a small tilt angle, may be canceled by the retardation layer 18′ containing discotic molecules (that is, negative-birefringent materials) fixed in a reverse hybrid alignment, in the same manner as the liquid crystal cell LC shown in FIG. 1. Since the reverse hybrid alignment, rather than the normal hybrid alignment, may more readily be formed in a stable manner by using some types of discotic liquid crystals, that negative-birefringent materials, so that crystal cell LC′ shown in FIG. 4 is superior in terms of productivity.

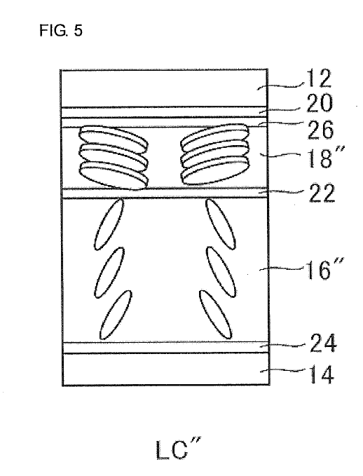

FIG. 5 shows a schematic sectional view of a liquid crystal cell LC″ according to still another embodiment of the present invention. FIG. 5 illustrates an embodiment having the same configuration as shown in FIG. 1, except that the liquid crystal layer 16 is replaced with a liquid crystal layer 16″ formed of a uniformly-tilted alignment, and except that the retardation layer 18 is replaced with a retardation layer 18″ formed of a uniformly-tilted-alignment. In the liquid crystal cell LC″ shown in FIG. 5, the liquid crystal molecules in the liquid crystal layer 16″ are aligned at a uniform small tilt angle over the entire range of layer, and birefringence which is caused due to the uniformly-tilted alignment is canceled by the uniformly-tilted alignment of the negative-birefringent material of the retardation layer 18″. In the liquid crystal cell LC″ shown in FIG. 5, if the retardation layer 18″ and other optical components, including the liquid crystal layer 16″, are disposed so that their optical directions satisfy the relation shown in FIG. 2, birefringence, which is caused due to the alignment of liquid crystal molecules in the liquid crystal layer 16 in the black state with a small tilt angle, may be canceled by the retardation layer 18″ containing discotic molecules (that is, negative-birefringent materials) fixed in the uniformly-tilted alignment state, in the same manner as the liquid crystal cell LC shown in FIG. 1. The uniformly-tilted alignment of the liquid crystal layer 16″ herein may be formed by using the alignment films 22 and 24 formed of materials having an equal regulatory force of alignment, and rubbed in a parallel direction.

While FIG. 1 and FIG. 4 show exemplary combinations of the liquid crystal layer 16 formed of a non-uniformly-tilted alignment and the retardation layers 18 and 18′ formed of a hybrid alignment, and while FIG. 5 shows an exemplary combination of the liquid crystal layer 16″ formed of a uniformly-tilted alignment and the retardation layer 18″formed of a uniformly tilted-alignment, the effect of the present invention may be obtained also by combining the liquid crystal layer formed of a non-uniformly-tilted alignment and the retardation layer formed of a uniformly-tilted alignment, or by combining the liquid crystal layer formed of a uniformly-tilted alignment and the retardation layer formed of a hybrid alignment.

While the liquid crystal cell LC, LC′, or LC″, shown in FIG. 1, 4, or 5, is the embodiment in which the color filter 20 is disposed between the substrate 12 and the retardation layer 18, also the embodiment, in which the color filter 20 is disposed between the retardation layer 18 and the liquid crystal layer 16, may exhibit the similar effect. The retardation layer 18 may still alternatively be disposed between the substrate 14 and the liquid crystal layer 16. Note that, in this embodiment, the tilt-alignment of the liquid crystal layer 16 may preferably be not uniform, such as having a larger tilt angle on the lower side and having a smaller tilt angle on the upper side.

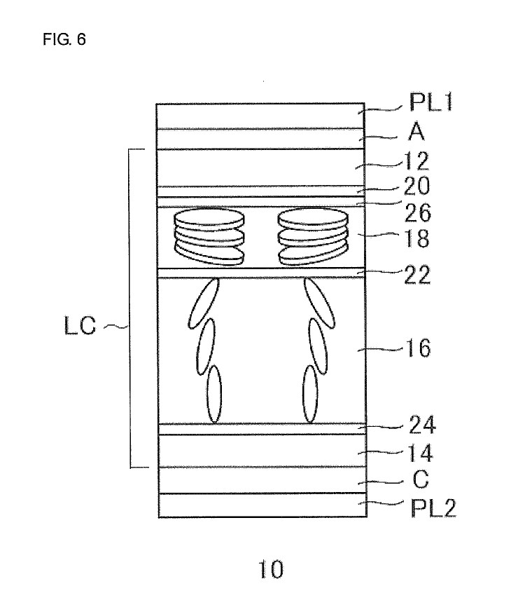

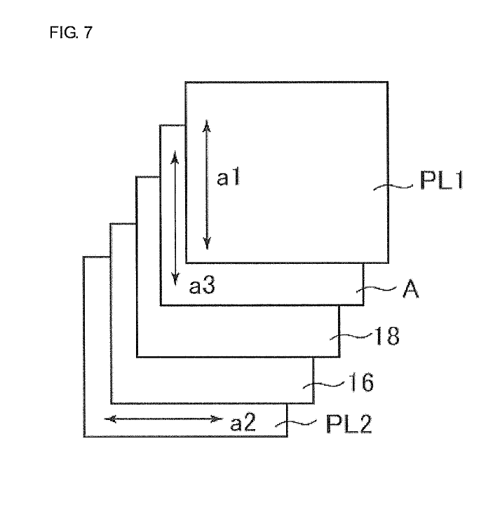

FIG. 6 is a schematic sectional view illustrating one example of a liquid crystal display device of the present invention, having the liquid crystal cell LC shown in FIG. 1. The liquid crystal display device 10 shown in FIG. 6 has a pair of polarizing plates PL1 and PL2, and a liquid crystal cell LC disposed in between. A negative C-plate C is disposed between the polarizing plate PL1 and the liquid crystal cell LC, and an A-plate A is disposed between the liquid crystal cell LC and the polarizing plate PL2. The negative C-plate C and the A-plate A exhibit an effect of canceling leakage of light in the black state, ascribable to that the absorption axes of the polarizing plates PL1 and PL2 shift from the orthogonal arrangement when viewed in oblique directions. The A-plate disposed for this purpose is generally disposed, as shown in FIG. 7, so that the in-plane slow axis a3 thereof is aligned in parallel or orthogonal to the absorption axes a1 and a2 of the polarizing plates PL1 and PL2. Operations of optical compensation in a VA-mode liquid crystal display device, contributed by the negative C-plate and the A-plate, have been described in various documents (for example, Japanese Examined Patent No. 3648240), and also adoptable examples of the negative C-plate and the A-plate have been described in various documents. All of combinations of the negative C-plate and the A-plate described in these documents may be adoptable to the present invention. Retardation Rth of the C-plate in the thickness-wise direction thereof preferably have a value which is obtained by subtracting Rth of other optically anisotropic layers which lies between two polarizing plates and having a negative C-plate components, such as polarizing plate protective film, the retardation layer of the present invention, or the color filter layer, from Rth of the liquid crystal layer in the black state. For this reason, depending on the configuration to be adopted, even configurations without the negative C-plate C may successfully cancel the leakage of light in oblique directions.

Similarly, as an optical compensation mechanism for canceling leakage of light in the black state of the VA-mode liquid crystal display device, ascribable to that the absorption axes of the polarizing plates shift from the orthogonal arrangement when viewed in oblique directions, also known are an optical compensation mechanism making use of two optically-biaxial retardation films (for example, Japanese Examined Patent No. 3330574); and an NRZ-type optical compensation mechanism (for example, Japanese Laid-open Patent Publication No. 2002-107541). Of course, retardation components of these optical compensation mechanisms may be disposed, in place of the negative C-plate C and the A-plate A shown in FIG. 6. Also in these modes, the retardation component having the in-plane slow axis is disposed so that the in-plane slow axis thereof is aligned in parallel or orthogonal to the absorption axes a1 and a2 of the polarizing plate PL1 and PL2.

For any embodiments where the retardation components, such as the negative C-plate, the A-plate, the biaxial retardation film and so forth, used for the above-described optical compensation mechanisms, are composed of polymer films, the retardation components may be constituents of the polarizing plates PL1 and PL2, and may be protective films of the polarizers (protective films disposed between the liquid crystal cell and each of the polarizers).

FIG. 6 is preferably assumed that the top is directed to the screen side, from the positional viewpoint of the color filter 20. Similar effects may, however, be obtained whichever of the top and bottom is directed to the screen side and the back light side, from the positional viewpoint of the retardation layers 18 as described in the above.

While FIG. 2 and FIG. 3 showed exemplary modes where the region corresponded to a single subpixel of the liquid crystal is composed of four domains, the present invention is of course not limited to these modes. The effect of the present invention may be expectable from any modes where the region corresponded to a single subpixel is composed of two or larger number of domains, such as two domains, six domains, and 8 domains. Note that, in a black-and-white image display device having no RGB subpixels, the region corresponded to a single pixel of the liquid crystal layer is composed of a plurality of domains.

The present invention employs a multi-domain liquid crystal layer in which the liquid crystal molecules are tilt-aligned in the black state so that the average tilt angle falls in the range exceeding 1° and not exceeding 20°, with respect to the direction of normal line on the two substrate, and in which directions of tilting of the liquid crystal molecules different between at least two domains. The tilt angle preferably falls in the range from 2 to 10° in view of improving the operation characteristics. The multi-domain liquid crystal layer in the present invention may be formed, as described in the above, by masked rubbing of the surface of the alignment film repeated in different directions; or by irradiating a photo-alignable film, a plural number of times, with light from different directions through photomasks, or irradiating polarized lights having different directions of polarization, where these processes of irradiation are repeated a plural number of times. Of course, the multi-domain configuration may be obtained by making use of structures (ribs or slits) on the surface of substrate. From the viewpoint of the effect of the present invention, stating that the contrast may further be improved, it is more preferable to form the domains by using the above-described techniques based on masked rubbing or photo-alignment, rather than by using the structures on the surface of substrate. The multi-domain configuration of the liquid crystal layer making use of the alignment film may be introduced referring to materials and methods described in Japanese Laid-Open Patent Publication No. 2002-357830.

The multi-domain liquid crystal layer used in the present invention contains positive-birefringent liquid crystal molecules, and typically contains a nematic liquid crystal which has conventionally been used for various types of liquid crystal cell.

The multi-domain retardation layer disposed in the liquid crystal cell in the present invention will further be detailed.

In the present invention, the retardation layer disposed in the liquid crystal cell is a retardation layer which contains negative-birefringent molecules fixed in an alignment state, wherein a region corresponding to a single pixel or a single subpixel is composed of a plurality of domains, and the directions of the in-plane slow axis are different between at least two domains. Since, for improving the operation characteristics, the retardation layer cancels birefringence, which is caused due to the alignment of liquid crystal molecules in the liquid crystal layer in the black state with a small tilt angle, and prevents the contrast from lowering, retardation in-plane of the retardation layer is preferably nearly equal to Δn·d (Δn represents the birefringence of the liquid crystal layer, and d represents the thickness of the liquid crystal layer) of the liquid crystal layer in the black state at the same wavelength. Too large retardation in-plane, Re, of the retardation layer may conversely result in reduced contrast. From this point of view, Re(550) of the retardation layer is preferably equal to or smaller than 20, and more preferably from 0.5 to 10 nm.

Note that, while the above-described retardation layer has a multi-domain structure, the only a single Re value corresponding to the measurement wavelength may be obtained by measuring Re according to the above-described method.

Examples of the negative-birefringent material adoptable to formation of the retardation layer include discotic compounds (preferably discotic liquid crystalline compounds). The discotic compounds which can be used for preparing the retardation layer are not specifically limited, wherein various discotic compounds such as triphenylene liquid crystal, tri-substituted benzene derivative, triazine derivatives, uric acid derivatives, and chromonic liquid crystal may be used. These compounds may be polymerizable. More specifically, examples of the discotic compound which can be used for preparing the retardation layer include the discotic compounds represented by formula (DI) shown below.

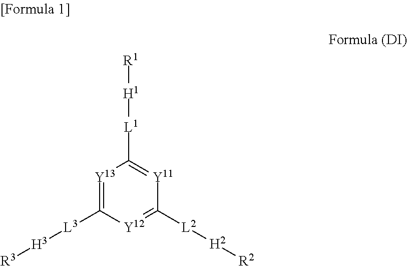

In formula (DI), Y¹¹, Y¹² and Y¹³ each independently represent a methine group or a nitrogen atom. In the formula, L¹, L² and L³ each independently represent a single bond or a bivalent linking group. In the formula, H¹, H² and H³ each independently represent following formula (DI-A) or (DI-B). In the formula, R¹, R² and R³ each independently represent following formula (DI-R).

In formula (DI), Y¹¹, Y¹² and Y¹³ each independently represent a methine group or a nitrogen atom. When each of Y¹¹, Y¹² and Y¹³ each is a methine group, the hydrogen atom of the methine group may be substituted with a substituent. Examples of the substituent of the methine group include an alkyl group, an alkoxy group, an aryloxy group, an acyl group, an alkoxycarbonyl group, an acyloxy group, an acylamino group, an alkoxycarbonylamino group, an alkylthio group, an arylthio group, a halogen atom, and a cyano group. Among those, preferred are an alkyl group, an alkoxy group, an alkoxycarbonyl group, an acyloxy group, a halogen atom and a cyano group; more preferred are an alkyl group having from 1 to 12 carbon atoms (the term “carbon atoms” means hydrocarbons in a substituent, and the terms appearing in the description of the substituent of the discotic liquid crystal compound have the same meaning), an alkoxy group having from 1 to 12 carbon atoms, an alkoxycarbonyl group having from 2 to 12 carbon atoms, an acyloxy group having from 2 to 12 carbon atoms, a halogen atom and a cyano group.

Preferably, Y¹¹, Y¹² and Y¹³ are all methine groups, more preferably non-substituted methine groups.

In formula (DI), L¹, L² and L³ each independently represent a single bond or a bivalent linking group. The bivalent linking group is preferably selected from —O—, —S—, —C(═O)—, —NR⁷—, —CH═CH—, —C≡C—, a bivalent cyclic group, and their combinations. R⁷ represents an alkyl group having from 1 to 7 carbon atoms, or a hydrogen atom, preferably an alkyl group having from 1 to 4 carbon atoms, or a hydrogen atom, more preferably a methyl, an ethyl or a hydrogen atom, even more preferably a hydrogen atom.

The bivalent cyclic group for L¹, L² and L³ is preferably a 5-membered, 6-membered or 7-membered group, more preferably a 5-membered or 6-membered group, even more preferably a 6-membered group. The ring in the cyclic group may be a condensed ring. However, a monocyclic ring is preferred to a condensed ring for it. The ring in the cyclic ring may be any of an aromatic ring, an aliphatic ring, or a hetero ring. Examples of the aromatic ring are a benzene ring and a naphthalene ring. An example of the aliphatic ring is a cyclohexane ring. Examples of the hetero ring are a pyridine ring and a pyrimidine ring. Preferably, the cyclic group contains an aromatic ring and a hetero ring.

Of the bivalent cyclic group, the benzene ring-having cyclic group is preferably a 1,4-phenylene group. The naphthalene ring-having cyclic group is preferably a naphthalene-1,5-diyl group or a naphthalene-2,6-diyl group. The pyridine ring-having cyclic group is preferably a pyridine-2,5-diyl group. The pyrimidine ring-having cyclic group is preferably a pyrimidin-2,5-diyl group.

The bivalent cyclic group for L¹, L² and L³ may have a substituent. Examples of the substituent are a halogen atom, a cyano group, a nitro group, an alkyl group having from 1 to 16 carbon atoms, an alkenyl group having from 2 to 16 carbon atoms, an alkynyl group having from 2 to 16 carbon atoms, a halogen atom-substituted alkyl group having from 1 to 16 carbon atoms, an alkoxy group having from 1 to 16 carbon atoms, an acyl group having from 2 to 16 carbon atoms, an alkylthio group having from 1 to 16 carbon atoms, an acyloxy group having from 2 to 16 carbon atoms, an alkoxycarbonyl group having from 2 to 16 carbon atoms, a carbamoyl group, an alkyl group-substituted carbamoyl group having from 2 to 16 carbon atoms, and an acylamino group having from 2 to 16 carbon atoms.

In the formula, L¹, L² and L³ are preferably a single bond, *—O—CO—, *—CO—O—, —CH═CH—, *—C≡C—, *“bivalent cyclic group”-, *—O—CO-“bivalent cyclic group”-, —CO—O-“bivalent cyclic group”-, *—CH═CH-“bivalent cyclic group”-, *—C≡C-“bivalent cyclic group”-, *-“bivalent cyclic group”-O—CO—, *-“bivalent cyclic group”-CO—O—, *-“bivalent cyclic group”-CH═CH—, or *-“bivalent cyclic group”-C≡C—. More preferably, they are a single bond, *—CH═CH—, *—CH═CH-“bivalent cyclic group”— or *—C≡C-“bivalent cyclic group”-, even more preferably a single bond. In the examples, “*” indicates the position at which the group bonds to the 6-membered ring of formula (DI) that contains Y¹¹, Y¹² and Y¹³.

In formula (DI), H¹, H² and H³ each independently represent the following formula (DI-A) or (DI-B):

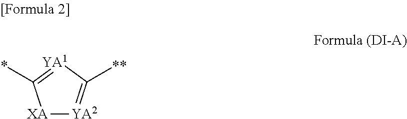

In formula (DI-A), YA¹ and YA² each independently represent a methine group or a nitrogen atom. Preferably, at least one of YA¹ and YA² is a nitrogen atom, more preferably they are both nitrogen atoms. XA represents an oxygen atom, a sulfur atom, a methylene group or an imino group. XA is preferably an oxygen atom. * indicates the position at which the formula bonds to any of L¹ to L³; and ** indicates the position at which the formula bonds to any of R¹ to R³.

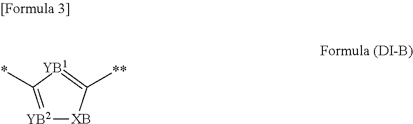

In formula (DI-B), YB¹ and YB² each independently represent a methine group or a nitrogen atom. Preferably, at least one of YB¹ and YB² is a nitrogen atom, more preferably they are both nitrogen atoms. XB represents an oxygen atom, a sulfur atom, a methylene group or an imino group. XB is preferably an oxygen atom. * indicates the position at which the formula bonds to any of L¹ to L³; and ** indicates the position at which the formula bonds to any of R¹ to R³.

In the formula, R¹, R² and R³ each independently represent the following formula (DI-R):

*-(-L²¹-F¹)ₙ₁-L²²-L²³-Q¹ (DI-R)

In formula (DI-R), * indicates the position at which the formula bonds to H¹, H² or H³ in formula (DI). F¹ represents a bivalent linking group having at least one cyclic structure. L²¹ represents a single bond or a bivalent linking group. When L²¹ is a bivalent linking group, it is preferably selected from a group consisting of —O—, —S—, —C(═O)—, —NR⁷—, —CH═CH—, —C≡C—, and their combination. R⁷ represents an alkyl group having from 1 to 7 carbon atoms, or a hydrogen atom, preferably an alkyl group having from 1 to 4 carbon atoms, or a hydrogen atom, more preferably a methyl group, an ethyl group or a hydrogen atom, even more preferably a hydrogen atom.

In the formula, L²¹ is preferably a single bond, **—O—CO—, **—CO—O—, —CH═CH— or **—C≡C— (in which ** indicates the left side of L²¹ in formula (DI-R)). More preferably it is a single bond.

In formula (DI-R), F¹ represents a bivalent cyclic linking group having at least one cyclic structure. The cyclic structure is preferably a 5-membered ring, a 6-membered ring, or a 7-membered ring, more preferably a 5-membered ring or a 6-membered ring, even more preferably a 6-membered ring. The cyclic structure may be a condensed ring. However, a monocyclic ring is preferred to a condensed ring for it. The ring in the cyclic ring may be any of an aromatic ring, an aliphatic ring, or a hetero ring. Examples of the aromatic ring are a benzene ring, a naphthalene ring, an anthracene ring, a phenanthrene ring. An example of the aliphatic ring is a cyclohexane ring. Examples of the hetero ring are a pyridine ring and a pyrimidine ring.

The benzene ring-having group for F¹ is preferably a 1,4-phenylene group or a 1,3-phenylene group. The naphthalene ring-having group is preferably a naphthalene-1,4-diyl group, a naphthalene-1,5-diyl group, a naphthalene-1,6-diyl group, a naphthalene-2,5-diyl group, a naphthalene-2,6-diyl group, or a naphthalene-2,7-diyl group. The cyclohexane ring-having group is preferably a 1,4-cyclohexylene group. The pyridine ring-having group is preferably a pyridine-2,5-diyl group. The pyrimidine ring-having group is preferably a pyrimidin-2,5-diyl group. More preferably, F¹ is a 1,4-phenylene group, a 1,3-phenylenenaphthalene-2,6-diylgroup, or a 1,4-cyclohexylene group.

In the formula, F¹ may have a substituent. Examples of the substituent are a halogen atom (e.g., fluorine atom, chlorine atom, bromine atom, iodine atom), a cyano group, a nitro group, an alkyl group having from 1 to 16 carbon atoms, an alkenyl group having from 1 to 16 carbon atoms, an alkynyl group having from 2 to 16 carbon atoms, a halogen atom-substituted alkyl group having from 1 to 16 carbon atoms, an alkoxy group having from 1 to 16 carbon atoms, an acyl group having from 2 to 16 carbon atoms, an alkylthio group having from 1 to 16 carbon atoms, an acyloxy group having from 2 to 16 carbon atoms, an alkoxycarbonyl group having from 2 to 16 carbon atoms, a carbamoyl group, an alkyl group-substituted carbamoyl group having from 2 to 16 carbon atoms, and an acylamino group having from 2 to 16 carbon atoms. The substituent is preferably a halogen atom, a cyano group, an alkyl group having from 1 to 6 carbon atoms, a halogen atom-substituted alkyl group having from 1 to 6 carbon atoms, more preferably a halogen atom, an alkyl group having from 1 to 4 carbon atoms, a halogen atom-substituted alkyl group having from 1 to 4 carbon atoms, even more preferably a halogen atom, an alkyl group having from 1 to 3 carbon atoms, or a trifluoromethyl group.

In the formula, n1 indicates an integer of from 0 to 4. n1 is preferably an integer of from 1 to 3, more preferably 1 or 2. When n1 is 0, then L²² in formula (DI-R) directly bonds to any of H¹ to H³. When n1 is 2 or more, then (-L²¹-F¹)'s may be the same or different.

In the formula, L²² represents —O—, —O—CO—, —CO—O—, —O—CO—O—, —S—, —NH—, —SO₂—, —CH₂—, —CH═CH— or —C≡C—, preferably —O—, —O—CO—, —CO—O—, —O—CO—O—, —CH₂—, —CH═CH— or —C≡C—, more preferably —O—, —O—CO—, —CO—O—, —O—CO—O—, or —CH₂—.

When the above group has a hydrogen atom, then the hydrogen atom may be substituted with a substituent. Examples of the substituent are a halogen atom, a cyano group, a nitro group, an alkyl group having from 1 to 6 carbon atoms, a halogen atom-substituted alkyl group having from 1 to 6 carbon atoms, an alkoxy group having from 1 to 6 carbon atoms, an acyl group having from 2 to 6 carbon atoms, an alkylthio group having from 1 to 6 carbon atoms, an acyloxy group having from 2 to 6 carbon atoms, an alkoxycarbonyl group having from 2 to 6 carbon atoms, a carbamoyl group, an alkyl group-substituted carbamoyl group having from 2 to 6 carbon atoms, and an acylamino group having from 2 to 6 carbon atoms. Especially preferred are a halogen atom, and an alkyl group having from 1 to 6 carbon atoms.

In the formula, L²³ represents a bivalent linking group selected from —O—, —S—, —C(═O)—, —SO₂—, —NH—, —CH₂—, —CH═CH— and a group formed by linking two or more of these. The hydrogen atom in —NH—, —CH₂— and —CH═CH— may be substituted with any other substituent. Examples of the substituent are a halogen atom, a cyano group, a nitro group, an alkyl group having from 1 to 6 carbon atoms, a halogen atom-substituted alkyl group having from 1 to 6 carbon atoms, an alkoxy group having from 1 to 6 carbon atoms, an acyl group having from 2 to 6 carbon atoms, an alkylthio group having from 1 to 6 carbon atoms, an acyloxy group having from 2 to 6 carbon atoms, an alkoxycarbonyl group having from 2 to 6 carbon atoms, a carbamoyl group, an alkyl group-substituted carbamoyl group having from 2 to 6 carbon atoms, and an acylamino group having from 2 to 6 carbon atoms. Especially preferred are a halogen atom, and an alkyl group having from 1 to 6 carbon atoms. The group substituted with the substituent improves the solubility of the compound of formula (DI) in solvent, and therefore the composition can be readily prepared as a coating liquid.

In the formula, L²³ is preferably a linking group selected from a group consisting of —O—, —C(═O)—, —CH₂—, —CH═CH— and —C≡C—, and a group formed by linking two or more of these. L²³ preferably has from 1 to 20 carbon atoms, more preferably from 2 to 14 carbon atoms. Preferably, L²³ has from 1 to 16 (—CH₂—)'s, more preferably from 2 to 12 (—CH₂—)'s.

In the formula, Q¹ represents a polymerizing group or a hydrogen atom. In case where the compound of formula (DI) is used in producing optical films of which the retardation is required not to change by heat, such as optical compensatory films, Q¹ is preferably a polymerizing group. The polymerization for the group is preferably addition polymerization (including ring-cleavage polymerization) or polycondensation. In other words, the polymerizing group preferably has a functional group that enables addition polymerization or polycondensation. Examples of the polymerizing group are shown below.

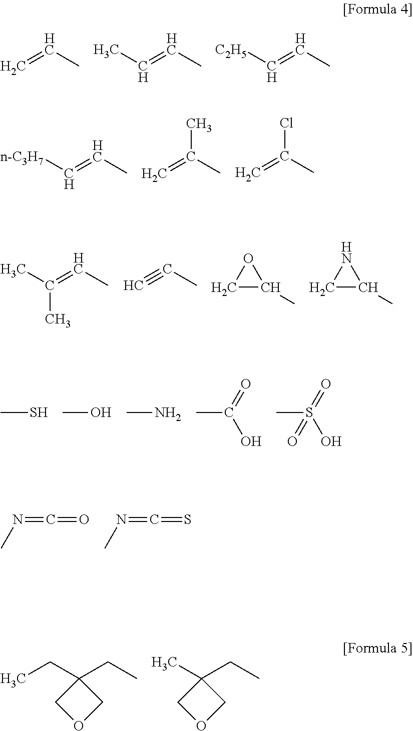

More preferably, the polymerizing group is addition-polymerizing functional group. The polymerizing group of the type is preferably a polymerizing ethylenic unsaturated group or a ring-cleavage polymerizing group.

Examples of the polymerizing ethylenic unsaturated group are the following (M-1) to (M-6):

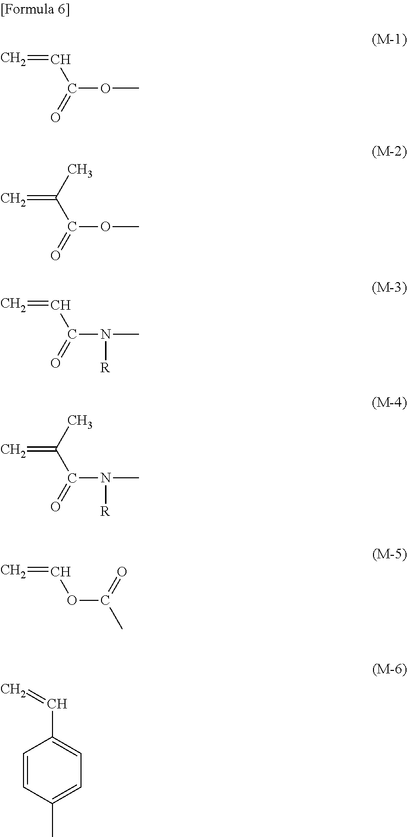

In formulae (M-3) and (M-4), R represents a hydrogen atom or an alkyl group. R is preferably a hydrogen atom or a methyl group. Of formulae (M-1) to (M-6), preferred are formulae (M-1) and (M-2), and more preferred is formula (M-1).

The ring-cleavage polymerizing group is preferably a cyclic ether group, more preferably an epoxy group or an oxetanyl group, most preferably an epoxy group.

Examples of the compound represented by formula (DI) include, but are not limited to, those shown below.

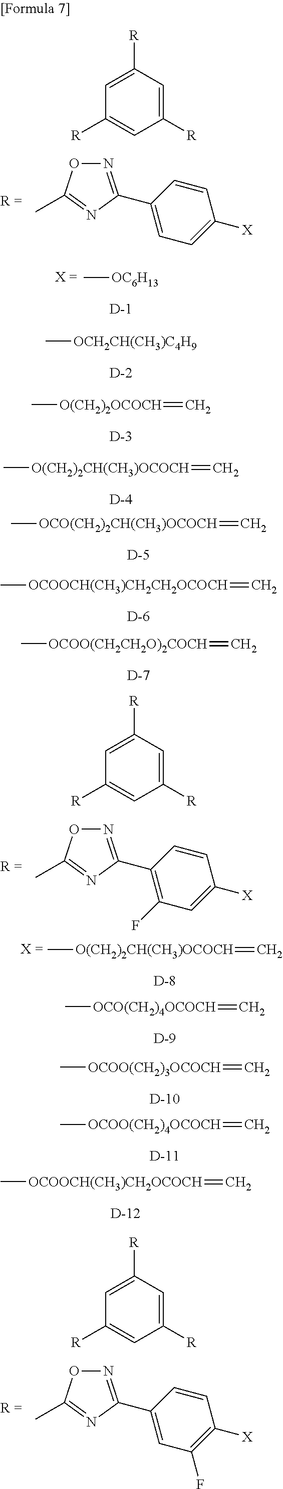

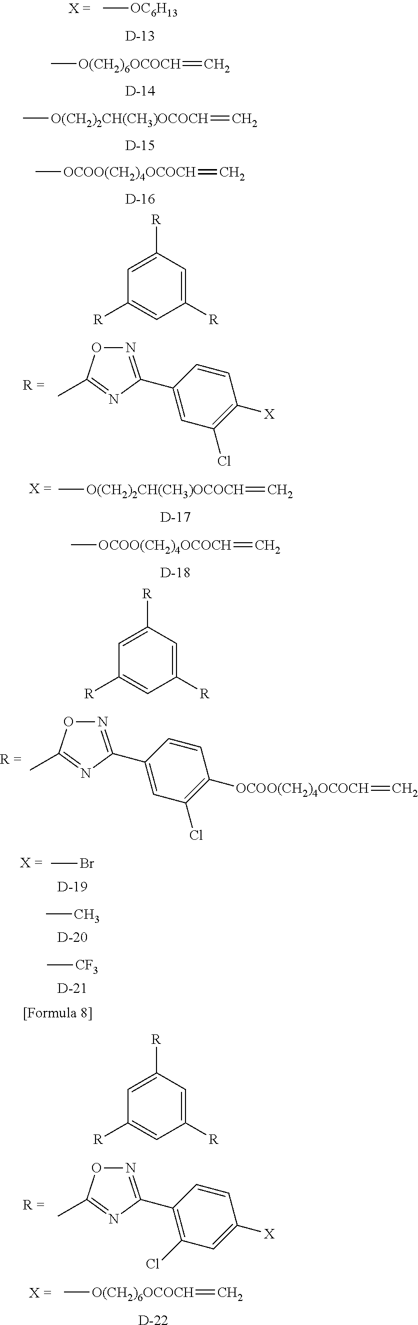

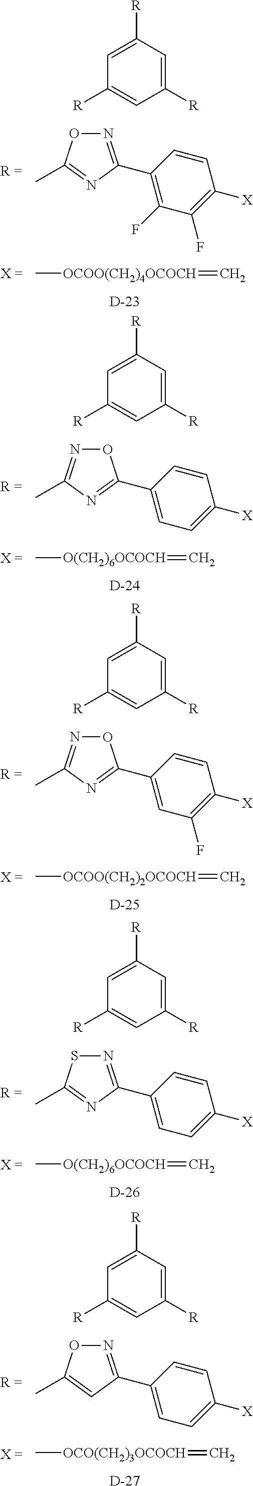

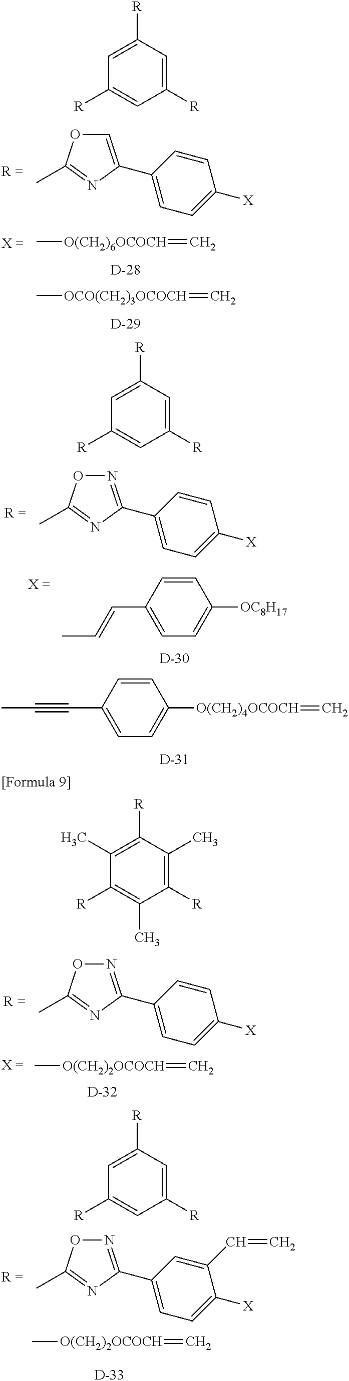

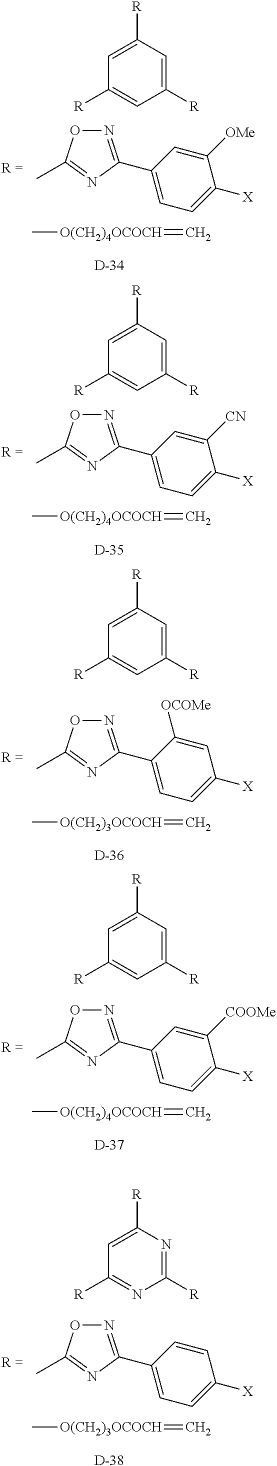

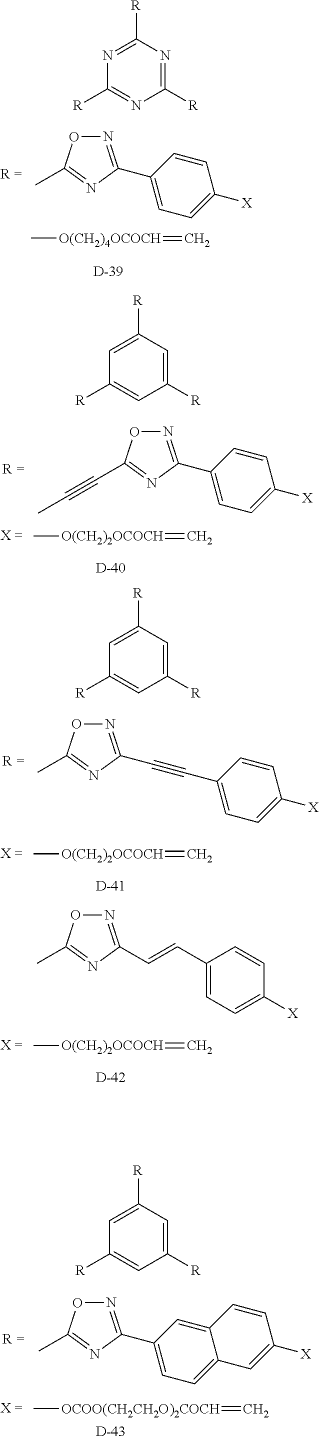

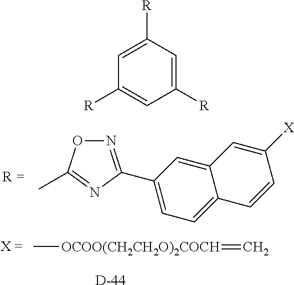

Examples of the compound represented by formula (DIII) include those shown below.

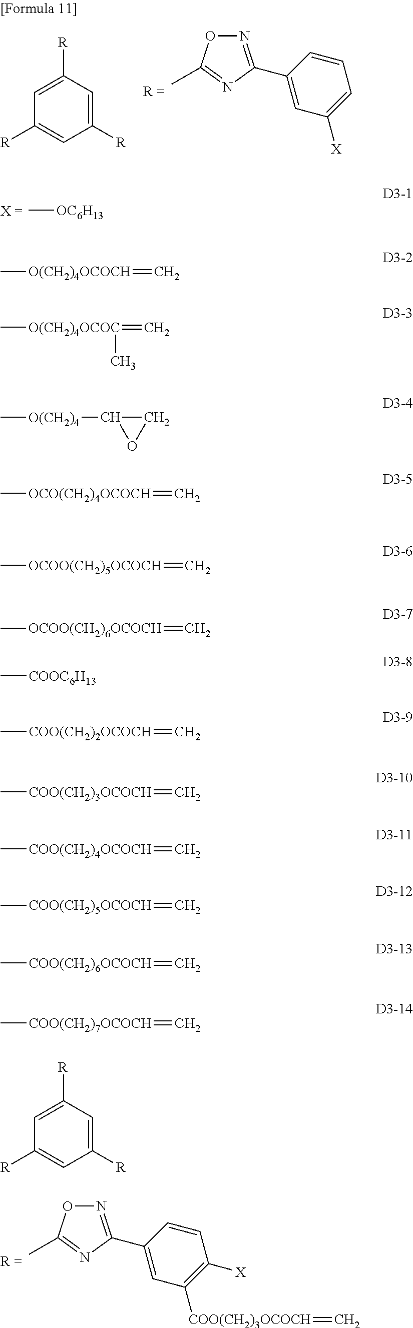

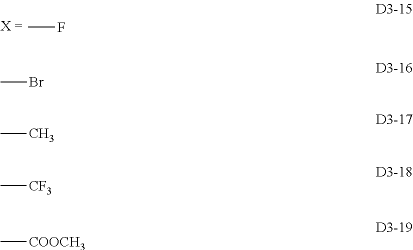

Examples of the discotic compound include those described in JP-A-2005-301206.

The retardation layer may be prepared as follows: the composition containing at least one discotic compound is applied to a surface (for example, a surface of an alignment layer), to form a coating layer; molecules of the discotic liquid crystal compound are aligned in a desired alignment state, and then polymerization of the composition is carried out, to fix the alignment state. The desired alignment state to be fixed may be varied depending on the types of the liquid crystal compound(s) to be used or the alignment state of the target liquid crystal layer under being applied with no driving voltage. Preferably, the retardation layer is prepared by fixing a uniformly-inclined alignment state or a hybrid alignment state of a discotic compound(s). The term “hybrid alignment” means any alignment state in which the directions of the directors of liquid crystal molecules vary along the thickness direction continuously. Regarding a discotic molecule, the director thereof is any diameter of the discotic plane. The hybrid alignment may be any regular hybrid alignment in which the tilt angle at the air-interface side is larger, or any reverse hybrid alignment in which the tilt angle at the alignment-layer side is larger. The averaged tilt angle of discotic liquid crystal molecules in the retardation layer may be same as that of liquid crystal molecules in the liquid crystal layer, however, since, usually, the thickness of the retardation layer is thinner than that of the liquid crystal layer, the maximum tilt angle of the retardation layer may be larger than the averaged tilt angle of the liquid crystal layer.

For aligning molecules of the discotic liquid crystal compound in the desired alignment state, or for improving the coating properties or curable properties, one or more additives may be added to the composition. For aligning molecules of the discotic compound in a hybrid alignment, any additive capable of controlling the alignment at the air-interface side of the layer (hereinafter, referred to as “agent for controlling alignment at the air-interface) may be added. Examples of such an additive include low-molecular or high-molecular weight compounds having fluorinated alkyl group. Examples of the agent for controlling alignment at the air-interface which can be used include the compounds described in JP-A-2006-267171. Any surfactant may be added to the composition for improving the coating properties of the composition. Preferable examples of the surfactant, which can be used, include fluorinated compounds; and, in particular, the compounds described in JP-A-2001-330725, paragraphs of [0028]-[0056], are preferable. The commercially available “MEGAFAC F780” (manufactured by DIC Corporation) may be also used.

The composition preferably contains any polymerization initiator. The polymerization initiator may be a thermal polymerization initiator or a photo-polymerization initiator. In terms of easiness in controlling or the like, photo-polymerization initiators are preferable. Preferred examples of the polymerization initiator that generates radicals by the action of light given thereto are α-carbonyl compounds (as in U.S. Pat. Nos. 2,367,661, 2,367,670), acyloin ethers (as in U.S. Pat. No. 2,448,828,) α-hydrocarbon-substituted aromatic acyloin compounds (as in U.S. Pat. No. 2,722,512), polycyclic quinone compounds (as in U.S. Pat. Nos. 3,046,127, 2,951,758), combination of triarylimidazole dimer and p-aminophenyl ketone (as in U.S. Pat. No. 3,549,367), acridine and phenazine compounds (as in JP-A 60-105667, U.S. Pat. No. 4,239,850) and oxadiazole compounds (as in U.S. Pat. No. 4,212,970), acetophenone compounds, benzoin ether compounds, benzyl compounds, benzophenone compounds, thioxanthone compounds.

For the purpose of increasing the sensitivity thereof, a sensitizer may be added to the polymerization initiator. Examples of the sensitizer are n-butylamine, triethylamine, tri-n-butyl phosphine, and thioxanthone.

Plural types of the photopolymerization initiators may be combined and used herein, and an amount thereof is preferably from 0.01 to 20% by mass of the solid content of the coating liquid, more preferably from 0.5 to 5% by mass. For light irradiation for polymerization of the discotic liquid-crystal compound, preferably used are UV rays.

The composition may contain any polymerizable monomer along with the discotic compound. Preferable examples of the polymerizable compound include compounds having vinyl, vinyloxy, acryloyl, or methacryloyl group. It is to be noted that using any poly-functional monomer, having two or more polymerizable function groups, is preferable in terms of improving the durability.

The retardation layer may be prepared as follows. The composition is prepared as a coating liquid; the coating liquid is applied to a surface of an alignment layer formed on a support, and is dried thereby to remove the solvent from the composition and thereby to align molecules of the discotic compound in an alignment state; and then the alignment state is fixed by carrying out the polymerization of the composition. Examples of the coating method include curtain coating, dip coating, spin coating, print coating, spray coating, slot coating, roll coating, slide coating, blade coating, gravure coating and wire-bar coating.

When the coating layer is dried, the layer may be heated. While the coating layer is dried to remove the solvent from the coating layer, the desired alignment state in which discotic molecules in the coating layer are aligned may be obtained.

Next, the polymerization is carried out under irradiation of UV light or the like, thereby to fix the alignment state. In this way, the retardation layer is formed. Light to be used for polymerization is preferably UV light. UV rays are preferably used for irradiation with light for polymerization. The irradiation energy is preferably from 20 mJ/cm² to 50 J/cm², more preferably from 100 mJ/cm² to 800 mJ/cm². For promoting the optical polymerization, the light irradiation may be attained under heat.

Thus formed, the thickness of the optically-anisotropic layer may vary, depending on the optimum retardation value in accordance with the use of the layer for optical compensation or the like, but is preferably from 0.1 to 10 μM, more preferably from 0.5 to 5 μm.

The retardation layer is preferably formed using an alignment film. Examples of the alignment film adoptable herein include poly(vinyl alcohol) film and polyimide film. If the retardation layer is formed by applying a composition which contains a discotic compound to the rubbed surface of the alignment film to form a coated film and to align discotic molecules in a uniformly-tilted alignment or in a hybrid alignment, and then by fixing the state of alignment by curing, the in-plane slow axis of the retardation layer lies in the direction normal to the direction of rubbing. Accordingly, the multi-domain retardation layer, having the in-plane slow axes along the different directions among the domains, may readily be prepared by using an alignment film which is formed by repeatedly subjecting the surface of a polymer film, such as poly(vinyl alcohol) film, to a masked-rubbing treatment at a plural number of times in different directions. As described in the above, when the exemplary combination of the retardation layer and the liquid crystal layer shown in FIG. 2 is prepared, it is preferable to divide each of alignment films for forming the retardation layer and the liquid crystal layer into equally-sized domains, and to rub the correspondent domains in parallel but inverted directions or, that is, anti-parallel direction. In this way, the tilted-alignment direction of the directors of discotic molecules in each domain of the retardation layer may be almost equal to the direction of tilting of the long axes of liquid crystal molecules in the correspondent domain of the liquid crystal layer. As a consequence, the in-plane slow axis of each domain of the retardation layer may be almost orthogonal to the direction of tilting of the long axes of liquid crystal molecules in the correspondent domain of the liquid crystal layer, as shown in FIG. 2(b).

### EXAMPLES

The present invention will further specifically be explained, referring to Examples. All materials, reagent, amounts and ratio of substances, operations and so forth may appropriately be modified without departing from the spirit of the present invention. The scope of the present invention is, therefore, not limited to the specific Examples described below.

### Example 1

Two sets of liquid crystal cell to be tested were manufactured using glass substrates with electrodes, each having a size of 30×40 mm, and were evaluated.

### 1. Manufacturing of Alignment Film Used for Retardation Layer

A commercially available polyimide alignment film (from Nissan Chemical Industries, Ltd., SE-150) was coated on each glass substrate with electrodes, and heated at 250° C. for one hour. The alignment film was then divided into four regions, and subjected to masked rubbing similarly to the retardation layer 18 shown in FIG. 2(b), with the axis of rubbing adjusted to 45° for the upper right region, 135° for the upper left region, 225° for the lower left region, and 315° for the lower right region.

### 2. Manufacturing of Multi-Domain Retardation Layer

A coating liquid was prepared by dissolving 100 parts by mass of a discotic liquid crystalline compound 1 shown below, 0.8 parts by mass of a polymer compound 2 shown below, parts by mass of a photo-polymerization initiator (Irgacure 907, from Ciba-Geigy Corporation), and parts by mass of a sensitizer (Kayacure DETX, from Nippon Kayaku Co., Ltd.) into 200 parts by mass of methyl ethyl ketone. The coating liquid was coated onto the surface of the alignment film by spin coating. The coated film was heated in a thermostat zone at 120° C. for 2 minutes, so as to align the discotic compound. Next, UV was irradiated in a 70° C. atmosphere for one minute, using a 120-W/cm high pressure mercury lamp, to thereby polymerize the discotic compound. The product was then allowed to cool down to room temperature. The retardation layer was manufactured in this way.

The retardation layer was found to have a thickness of 1.5 μm, and an in-plane retardation Re(550) at 550 nm of 3.4 nm. From observation of the direction of slow axis under a polarizing microscope, the direction of in-plane slow axis was found to be orthogonal to the axis of rubbing of the alignment film, in each domain. It was also confirmed from observation under a polarizing microscope on a freely rotatable stage, that the discotic compound were aligned while being inclined to the individual directions of rubbing, in the individual domains.

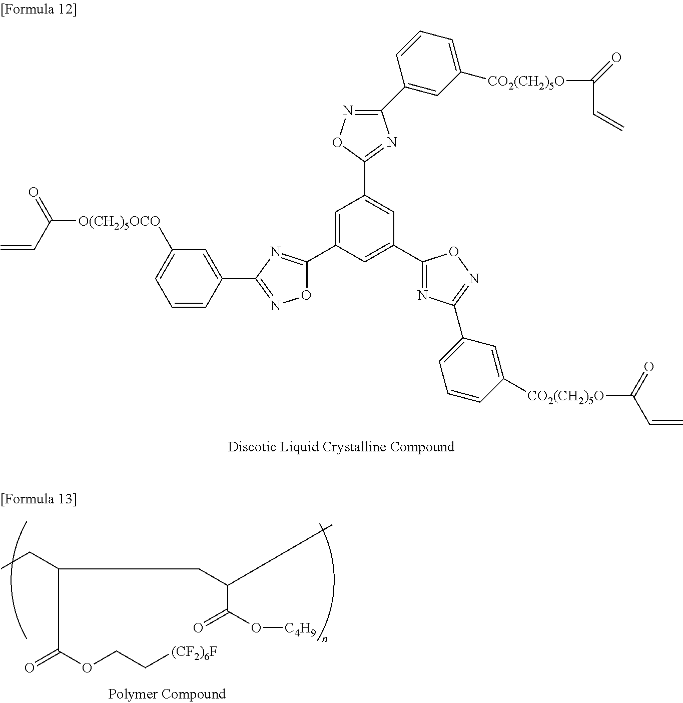

### 3. Measurement of Tilt Angle of Retardation Layer

The retardation layer having no multi-domain configuration was formed using materials and procedures similar to those described in the above, except that processes for forming the multi-domain configuration were not carried out. From measurement of incident angle dependence of retardation using an instrument called KOBRA, the average tilt angle of the discotic liquid crystal layer was calculated as 6.5°, based on 0° at one interface, and 13° at the other interface. The retardation layer was peeled off, a ultra-thin section was cut out therefrom, and the states of inclination at the individual interfaces were observed under a high-magnification immersion objective lens. The discotic compound was found to incline on the alignment film side, and to align horizontally (0° inclination) on the air interface side, showing a reverse hybrid alignment. The thickness of the retardation layer was found to be 1.5 μm, and Re(550) was 3.4 nm.

### 4. Producing Liquid Crystal Cell

A glass substrate with the multi-domain retardation layer was manufactured as described in the above, dipped in a solution prepared by diluting a domestic neutral detergent into 50 cc of water for 30 seconds, and was allowed to naturally dry. A commercially available composition for forming polyimide alignment film (from Nissan Chemical Industries, Ltd., SE-4811) was coated on the surface of the substrate, and the surface of the other glass substrate (cleaned), and sintered at 250° C. for one hour. The substrates were allowed to cool down to room temperature, and the polyimide alignment film formed on the glass substrate with retardation layer was rubbed by the procedures similar to those for the alignment film for the retardation layer, one-by-one for each of four regions, respectively along the axes same as the axes of rubbing of the alignment film for retardation layer corresponded to the individual regions. Note that the rubbing herein was given in anti-parallel to, or 180° turned from, the direction of rubbing of the alignment film for the correspondent retardation layer. The polyimide alignment film formed on the other substrate, having no retardation layer formed thereon, was not rubbed. Two these substrates were assembled so as to face the alignment films inward, to thereby form a liquid crystal cell. A liquid crystal material (“MLC6608”, from MERCK) having negative dielectric anisotropy was injected in between, and sealed. The liquid crystal exhibited positive birefringence, and retardation of the liquid crystal layer (that is, a product Δn·d of thickness d (μm) of the liquid crystal layer and refractive index anisotropy Δn) was adjusted to 330 nm. In this way, a VA-mode liquid crystal cell, having the multi-domain retardation layer and the multi-domain liquid crystal layer in the liquid crystal cell, was manufactured.

From study of incident angle dependence of Re of the liquid crystal cell, which was separately formed by similar procedures except that the retardation layer was not formed, and that the multi-domain configuration was not adopted, the liquid crystal cell was found to show inclined alignment at a tilt angle of 10° on the rubbed alignment film side, and nearly vertical alignment on the non-rubbed alignment film side. Accordingly, the average tilt angle of this liquid crystal layer was 5°. The Re(550) was found to be 3.0 nm.

### 5. Producing VA-Mode Liquid Crystal Display Device

A liquid crystal display device, configured similarly as shown in FIG. 6, was fabricated using the liquid crystal cell manufactured in the above. A retardation film having an Re(550) of 1 nm, and an Rth(550) of 38 nm was used as the negative C-plate C, and a norbornene-base polymer retardation film having an Re(550) of 100 nm and an Rth(550) of 50 nm was used as the A-plate A. These retardation films were incorporated as protective films for the polarizers of the polarizing plates PL1 and PL2, disposed on the liquid crystal cell side. The polarizing plates PL1 and PL2 were disposed, while aligning the respective absorption axes in the lateral direction and vertical direction with respective to the screen. More specifically, the absorption axes a1 and a2 of the polarizing plates PL1 and PL2, the in-plane slow axes 19a, 19b, 19c and 19d of the retardation layer 18, and the directions of tilting 17a, 17b, 17c and 17d of the liquid crystal layer 16 were aligned in the relation shown in FIG. 2. The norbornene-base polymer retardation film as the A-plate was disposed while aligning the in-plane slow axis thereof orthogonal to the absorption axis of the polarizing plate PL2.

### Comparative Example 1

The retardation layer was formed without rubbing the alignment film, in the process of forming the retardation layer in the liquid crystal cell in Example 1. The retardation layer was found to have an Re(550) of 0 nm, showing fully horizontal alignment of the discotic molecules in the layer. The thickness of the layer was found to be 1.5 μm. A VA-mode liquid crystal display device was manufactured similarly as described in Example 1, except that the above-described substrate with the retardation layer was used. In other words, the liquid crystal display device of Comparative Example 1 may be understood as an example based on a combination of a liquid crystal layer characterized by multi-domain inclined alignment at a small tilt angle, and a uniform in-cell retardation layer without multi-domain configuration.

### Comparative Example 2

The retardation layer was formed without rubbing the alignment film, in the process of forming the retardation layer in the liquid crystal cell in Example 1. The retardation layer was found to have an Re(550) of 0 nm, showing fully horizontal alignment of the discotic molecules in the layer. The thickness of the layer was found to be 1.5 μm. A VA-mode liquid crystal display device was manufactured similarly as described in Example 1, but without rubbing the alignment film formed on the substrate with the retardation layer. The liquid crystal layer was found to have an Re(550) of 0 nm, showing the liquid crystal molecules aligned in parallel to the direction of normal line on the substrate. In other words, the liquid crystal display device of Comparative Example 2 may be understood as an example based a combination of a vertically-aligned liquid crystal layer without multi-domain configuration, and a uniform in-cell retardation layer without multi-domain configuration.

### [Measurement of Optical Characteristics]

Each of three display devices manufactured in the above were placed on a back light having a three-wavelength fluorescent tube, a diffuser plate and a prism sheet, and luminance was measured using a luminance meter (for example, BM-5 from TOPCON Corporation) over a 10-mm-diameter measurement area, in the axial direction (direction of normal line), and in directions of a 10° tilt angle away from the axial direction (synonymous with a 10° polar angle) at every 15° azimuth, and again in directions of a 20° tilt angle (synonymous with a 20° polar angle) at every 15° azimuth. An average value of luminance was determined for each of 10° and 20° tilt angles, and these average values were defined as luminance in the individual directions of the tilt angles. The procedures herein represent measurement in the black state.

Comparative Example 2 shows only a small leakage of light in the black state, by virtue of the full vertical alignment of the liquid crystal, so that the luminance was assumed as a reference, and the individual measured values of luminance of Example 1 and Comparative Example 1 were evaluated after dividing them by the measured value of luminance of Comparative Example 2.

The luminance of the display device of Example 1 was found to be 1.1 times in the axial direction, 1.3 times in the 10° tilted direction, and 1.8 times in the 20° tilted direction, proving that the luminance in the black state was nearly uniformly low, with a large black-and-white contrast. On the other hand, the luminance of the display device of Comparative Example 1 was found to be 3.6 times in the axial direction, 8.9 times in the 10° tilted direction, and 23 times in the 20° tilted direction, enough to understand that the luminance in the black state is large, with degraded black-and-white contrast.

The display device of Example 1 and the display device of Comparative Example 2 were further visually compared with respect to their responsibility while gradually elevating voltage to be applied. The display device of Example 1 was found to operate at a lower voltage as compared with Comparative Example 2, and was found to high in the luminance in the white state.

The present inventors also similarly evaluated the liquid crystal display device disclosed in Example of Japanese Laid-Open Patent Publication No. 2006-276849, configured by allowing the liquid crystal layer to align in an inclined manner at a small tilt angle in the black state for improved operation characteristics, only to find that the contrast in the axial direction degraded as compared with Example 1.

### EXPLANATION OF MARKS

10 liquid crystal display device
12, 14 cell substrate
16, 16″ liquid crystal layer
16a, 16b, 16c, 16d domain in region corresponded to one subpixel of liquid crystal layer
17a, 17b, 17c, 17d direction of tilting in each domain of liquid crystal layer
18, 18′, 18″ in-cell retardation layer
18a, 18b, 18c, 18d domain in region corresponded to one subpixel of in-cell retardation layer
19a, 19b, 19c, 19d in-plane slow axis of each domain of in-cell retardation layer
20 color filter
22, 24 alignment film used for liquid crystal layer
26 alignment film used for in-cell retardation layer
LC, LC′, LC″ liquid crystal cell
PL1, PL2 polarizing plate
A A-plate
C negative C-plate
a1, a2 polarizing plate absorption axis
a3 in-plane slow axis of A-plate

1. A liquid crystal display device comprising:
at least one polarizing plate; and
a liquid crystal cell comprising at least:
two substrates,
a multi-domain liquid crystal layer disposed between the two substrates, and comprising positive-birefringent liquid crystal molecules, and
a multi-domain retardation layer disposed between the liquid crystal layer and at least one of the two substrates, and comprising negative-birefringent molecules fixed in an alignment state;
the liquid crystal molecules in the liquid crystal layer being tilt-aligned in the black state so that the averaged tilt angle falls in the range from more than 1° to not more than 20°, with respect to the direction of normal lines of the two substrates, and having directions of tilting of the liquid crystal molecules different between at least two domains, and
the retardation layer having retardation in-plane at 550 nm, Re(550), of equal to or smaller than 20 nm, and having directions of in-plane slow axis different between at least two domains.

2. The liquid crystal display device of claim 1,
wherein the direction of tilting of the liquid crystal molecules in a domain of the liquid crystal layer intersects with the in-plane slow axis of a domain of the retardation layer corresponding to the domain of the liquid crystal layer when projected onto the same plane.

3. The liquid crystal display device of claim 1,
wherein the direction of tilting of the liquid crystal molecules in a domain of the liquid crystal layer intersects with the in-plane slow axis in a domain of the retardation layer, corresponding to the domain of the liquid crystal layer, by 90° when projected onto the same plane.

4. The liquid crystal display device of claim 1,
wherein the in-plane slow axis of each of the domains in the retardation layer is not parallel to the absorption axis of the at least one polarizing plate or not orthogonal to the absorption axis of the at least one polarizing plate.

5. The liquid crystal display device of claim 1,
wherein the direction of tilting of the liquid crystal molecules in a domain of the liquid crystal layer is same as the direction of tilting of the directors of the negative-birefringent molecules in a domain of the retardation layer corresponding to the domain of the liquid crystal layer.

6. The liquid crystal display device of claim 1,
wherein the retardation layer comprises discotic molecules fixed in a state of normal hybrid alignment or in a state of reverse hybrid alignment.

7. The liquid crystal display device of claim 1,
wherein corresponding domains of the liquid crystal layer and the retardation layer are layers formed on surfaces rubbed in parallel to each other in reverse directions.

8. The liquid crystal display device of claim 1,
wherein the liquid crystal layer and the retardation layer respectively have four domains corresponding to each other, and the positive-birefringent liquid crystal molecules in the liquid crystal layer in the black state and the negative-birefringent molecules in the retardation layer are aligned in the directions of 45°, 135°, 225° and 315° in the four domains respectively.

9. The liquid crystal display device of claim 1,
wherein the liquid crystal layer has two interfaces with different tilt angles of the liquid crystal molecules each other, and the retardation layer is disposed closer to the interface with a larger tilt angle of the different tilt angles.

10. The liquid crystal display device of claim 1, which employs a VA mode.

11. The liquid crystal display device of claim 1,
wherein the negative-birefringent molecules are molecules of a discotic liquid crystalline compound.

12. The liquid crystal display device of claim 11,
wherein the discotic liquid crystalline compound is a tri-substituted benzene derivative.

13. The liquid crystal display device of claim 1,
wherein the retardation layer is a cured film of a composition which comprises at least a discotic liquid crystalline compound, and a compound having a fluorinated alkyl group.

14. A liquid crystal cell comprising:
two substrates;
a multi-domain liquid crystal layer disposed between the two substrates, and comprising positive-birefringent liquid crystal molecules; and
a multi-domain retardation layer disposed between the liquid crystal layer and at least one of the two substrates, and comprising negative-birefringent molecules fixed in an alignment state;
the liquid crystal molecules in the liquid crystal layer being tilt-aligned in the black state so that the averaged tilt angle falls in the range from more than 1° to not more than 20°, with respect to the direction of normal lines of the two substrates, and having directions of tilting of the liquid crystal molecules different between at least two domains, and
the retardation layer having retardation in-plane at 550 nm, Re(550), of equal to or smaller than 20 nm, and having directions of in-plane slow axis different between at least two domains.
